(19) United States
(12) Patent Application Publication
(10) Pub. No.: US 2020/0253180 A1
(43) Pub. Date: Aug. 13, 2020

(54) REEL LOCKING SYSTEM

(71) Applicants: Charles William Thompson, San Marcos, CA (US); Douglas Daniel Crimaldi, San Marcos, CA (US)

(72) Inventors: Charles William Thompson, San Marcos, CA (US); Douglas Daniel Crimaldi, San Marcos, CA (US)

(21) Appl. No.: 16/779,618

(22) Filed: Feb. 2, 2020

Related U.S. Application Data
(60) Provisional application No. 62/803,399, filed on Feb. 8, 2019.

(51) Int. Cl. A01K 89/01

(52) U.S. Cl. CPC A01K 89/01127

(57) ABSTRACT

The present invention relates to a fishing reel locking system. In one embodiment, the reel locking system of the present invention comprises: a body made of one or more components; a locking mechanism that permits the user to manipulate the base in a manner that secures a fishing reel to a reel seat, fishing pole (referred to hereafter as rod), or any rod like object. In one embodiment, the reel locking system comprises a single base component, and a lock component that permits the user to lock the fishing reel to a rod or reel seat. In one embodiment the reel locking system comprises multiple base components and a lock component where all the components assemble and allows for the locking of the reel to the rod or reel seat.

### RELATED APPLICATION DATA

This application claims priority to and is a non-provisional of U.S. Provisional Patent Application No. 62/803,399 filed Feb. 8, 2019 and entitled “Reel Locking System,” the disclosure of which is hereby incorporated herein by reference in its entirety.

### FIELD OF THE INVENTION

The present invention relates to a fishing reel locking system. In one embodiment, the reel locking system of the present invention comprises: a body made of one or more components; a locking mechanism that permits the user to manipulate the base in a manner that secures a fishing reel to a reel seat, fishing pole (referred to hereafter as rod), or any rod like object. In one embodiment, the reel locking system comprises a single base component, and a lock component that permits the user to lock the fishing reel to a rod or reel seat. In one embodiment the reel locking system comprises multiple base components and a lock component where all the components assemble and allows for the locking of the reel to the rod or reel seat.

### BACKGROUND OF THE INVENTION

Current fishing reel and rod systems consist of the reel body, a mounting bracket, a reel seat, and the rod and prevent the user from locking the reel to the reel seat or rod. Further, the user cannot ensure the reel will not be removed from the rod without their approval or knowledge. For example, a typical fishing reel is not secured in a controlled manner that prevents unwanted removal of the reel from the rod or reel seat and can easily be stolen without the owner's knowledge.

In light of the above, there is a need in the art for a reel locking system that permits the user to manipulate and/or maneuver a locking mechanism onto the reel eliminating potential theft. In one such instance, the present invention enables such a goal to be accomplished via the use of reel, reel seat, and rod components and locking mechanism combination that is designed for detachment, alignment, and reattachment of the fishing reel in a secured manner to the reel seat, rod, or a combination of these components.

### SUMMARY OF THE INVENTION

The present invention relates to a fishing reel locking system. In one embodiment the fishing reel locking system of the present invention comprises: a reel; a reel clamp (also referred to hereafter as the coupling plate); and a locking structural cap that joins the reel to a fishing rod to provide a secure and user-controlled mounting of the reel to the rod to prevent removal. In one embodiment, the reel locking system comprises a single piece containing a structural cap with locking member that securely connects and locks in a user-controllable manner the fishing reel to the fishing rod, components of the fishing rod, or a combination of the components of the fishing rod (i.e. the rod, the reel seat, the reel foot, etc.).

In one embodiment the reel locking system comprises two or more individual pieces including a cap; a lock; and a structural plate or a combination of any of the three that securely connects and locks in a user-controllable manner the fishing reel to the fishing rod, components of the fishing rod, or a combination of the components of the fishing rod. In one embodiment, the reel locking system comprises one integrate structural cap and lock that securely connects and locks in a user-controllable manner the fishing reel to the fishing rod, components of the fishing rod, or a combination of the components of the fishing rod. The structural cap or series of components that combine to make a structural cap and lock create a secure connection between the reel and rod or rod components and allows only the owner to detach the reel from the rod or rod components using the appropriate unlocking mechanism.

In still another instance, the present invention relates to a fishing reel locking system that allows the user to prevent removal of the fishing reel from the fishing rod, components of the fishing rod, or a combination of the components of the fishing rod, using a locking mechanism integrated into the fishing reel, specifically into the reel foot, reel post, reel body, or any other part of the reel. Further the mechanism could be integrated into the reel seat, rod body, or any other part of the rod or reel seat. Further, with the lock mechanism integrated into the reel or separate from the reel in an additional component or a set of components, the lock mechanism could be permanently attached or removable from the component or components housing the lock.

In one embodiment, the present invention is directed to a fishing reel locking system that detachably locks a fishing reel to a fishing rod comprising: a reel seat formed in the fishing reel, where the reel seat is designed to receive at least one type of fishing reel having therein a reel foot; at least one reel seat securing member formed on at least one end of the reel seat, where the at least one reel seat securing member is designed to movably engage at least one portion of the reel foot of the fishing reel to be secured to the fishing rod; and at least one locking system designed to prevent the unwanted, or undesired, movement of the at least one reel seat securing member, thereby preventing the unwanted, or undesired, removal of the fishing reel from the fishing rod.

### BRIEF DESCRIPTION OF THE DRAWINGS

FIGS. 1 and 2 are illustrations of an existing spinning-/surf-/offshore-type fishing reel and rod assembly;

FIG. 3 is an illustration of an existing trolling-type fishing reel that can be mounted on the rod assembly of FIG. 1;

FIG. 4 is an illustration of an existing baitcasting-/conventional-type fishing reel that can be mounted on the rod assembly of FIG. 1;

FIGS. 5 and 6 are illustrations of an existing spinning-/surf-/offshore-type fishing reel and rod assembly utilizing a reel locking system according to one embodiment of the present invention;

FIG. 7 is an illustration of an existing trolling-type fishing reel and rod assembly utilizing a reel locking system according to one embodiment of the present invention;

FIG. 8 is an illustration of an existing spinning-/surf-/offshore-type fishing reel and rod assembly utilizing a reel locking system according to another embodiment of the present invention;

FIG. 9 is an illustration of an existing trolling-type fishing reel and rod assembly utilizing a reel locking system according to another embodiment of the present invention;

FIGS. 10A and 10B are close-up illustrations of one embodiment of a reel locking system in connection with the present invention;

FIG. 11 is an illustration of another embodiment of a reel locking system according to the present invention installed on a rod and reel system where the reel is a spinning-/surf-/offshore-type fishing reel;

FIGS. 12A and 12B are close-up illustrations of the reel locking system of FIG. 11;

FIG. 13 is an illustration of still another embodiment of a reel locking system of the present invention installed on a rod and reel system where the reel is a trolling-type fishing reel fishing reel;

FIGS. 14 and 15 are illustrations of still another embodiment of a reel locking system of the present invention installed on the rod and reel system where the reel is a baitcasting-/conventional-type fishing reel;

FIGS. 16 and 17 are illustrations of still another embodiment of a reel locking system of the present invention installed on the rod and reel system where the reel is a baitcasting-/conventional-type fishing reel;

FIGS. 18A and 18B are exploded views of the reel locking system of FIGS. 18 and 19;

FIGS. 19A and 19B are further exploded views of the reel locking system of FIGS. 16, 17, 18A and 19B; and

FIGS. 20A, 20B and 20C are further exploded views of the reel locking system of FIGS. 19A and 19B.

### DETAILED DESCRIPTION OF THE INVENTION AND THE FIGURES

As noted above, the present invention relates to a fishing reel locking system. In one embodiment, the reel locking system of the present invention comprises: a body made of one or more components; and a locking mechanism that permits the user to manipulate the reel, reel seat, and rod components in a manner that secures a fishing reel to a reel seat, fishing rod, or any rod like object. In one embodiment, the reel locking system comprises a single base component, and a lock component that permits the user to lock the fishing reel to a rod or reel seat. In one embodiment, the reel locking system comprises of multiple base components and a lock component where all the components assemble to allow for the locking of the reel to the rod or reel seat.

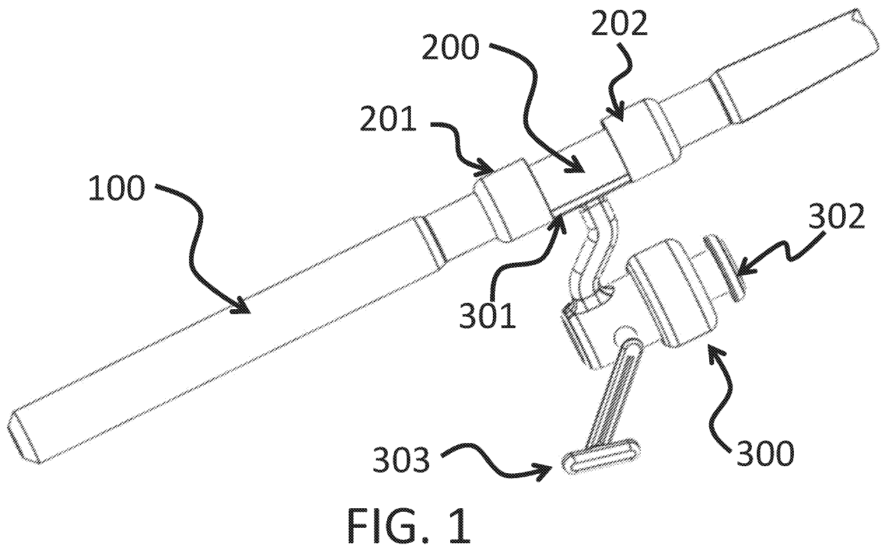

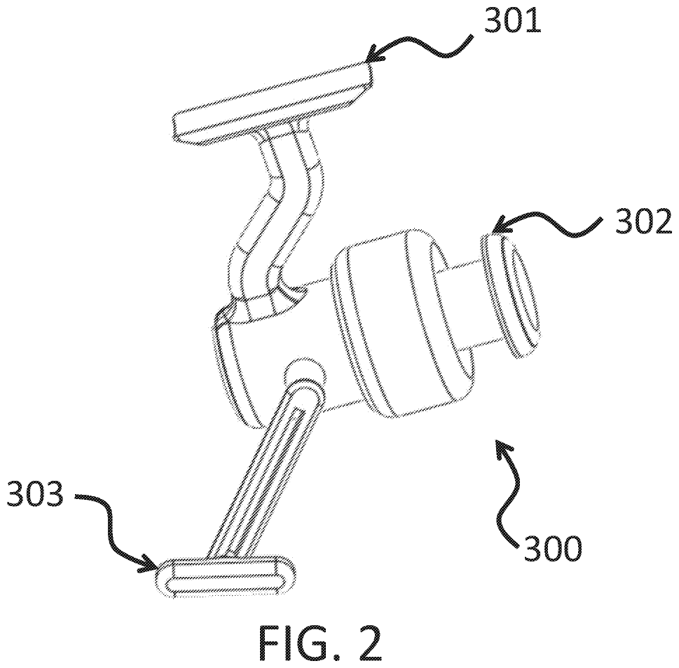

FIGS. 1 through 6 illustrate a variety of existing designs for fishing reel and rod systems. In FIGS. 1 and 2, a spinning-, surf-, and/or offshore-type fishing reel 300 is shown mounted to a rod assembly 100 with a flange locking system formed from a reel seat 200 and two reel seat securing members 201 and 202. Typically, reel seat securing members 201 and 202 are adjustable via threaded sections which permit for the movement of reel seat securing members 201 and 202 either away from one another, or towards one another. Via the movement of reel seat securing members 201 and 202 a reel foot, or flange, can be secured to rod assembly 100. Such a combination of elements permits the removable mounting of, a spinning-, surf-, and/or offshore-type fishing reel 300 to rod assembly 100. The combination of rod assembly 100 and reel seat 200 are commonly referred to as a fishing pole or fishing rod. As noted above, one, or both, of two reel seat securing members 201 and 202 are typically connected to reel seat 200 via a threaded section or threaded barrel design to allow for one securing member to move while the other is stationary, or for both securing members to move to permit securing of a fishing reel. Reel 300 comprises a reel foot 301 that facilitates mounting of reel 300 to reel seat 200 and rod assembly 100. Further, reel 300 further comprises of a reel body 302 which includes a wide range of components that create the functionality necessary for fishing including, but not limited to, a reel handle 303.

The mounting process for spinning reel 300 as illustrated in FIG. 1 includes various components such as rod assembly 100, reel 300 and reel seat 200, which can include a threaded section to permit two or more reel seat securing members 201 and 202 formed from separate or integrated threaded locking nuts. FIG. 1 specifically embodies reel seat 200, permanently affixed to rod assembly 100, including two reel seat securing members 201 and 202, one of which is the forward-most reel seat securing member 202 positioned toward the tip of rod and one which is the back-most reel seat securing member 201 positioned toward the butt of rod assembly 100. The forward most part of reel foot 301 which is located closest to the line spooling components of reel body 302, is inserted under the flange/threaded locking nut of reel seat securing member 202 and then laid flat on top of reel seat 200. The remaining flange/threaded locking nut of reel seat securing member 201 is then slid over the rear portion of reel foot 301 by turning a threaded nut integrated into reel seat securing member 201 as illustrated in FIG. 1 in order to tighten the threaded nut integrated of reel seat securing member 201 so as to secure reel foot 301 to rod assembly 100, thereby mounting reel 300 to rod assembly 100 via reel seat 200 and securing members 201 and 202. As would be apparent therefrom, the mounting process shown in this embodiment and equivalent mounting processes for spinning reels do not prevent theft or unwanted removal of a reel from rod assembly 100.

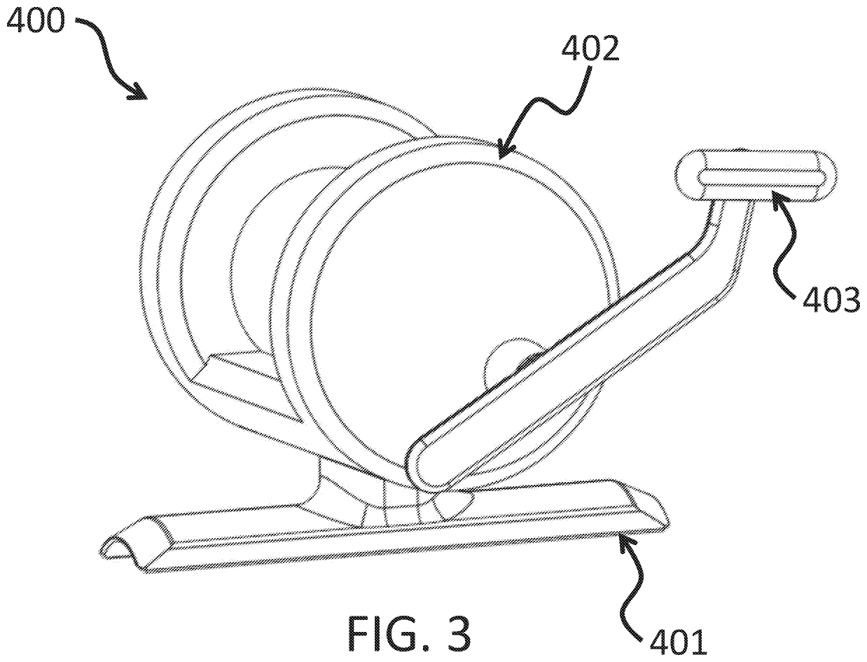

Given the disclosure above, FIGS. 2 and 3 illustrate additional types of fishing reels, trolling-type fishing reel and/or a baitcasting-/conventional-type fishing reel, that can be mounted to rod assembly 100 in a similar, or identical, manner similar to that of reel 100. Similar to reel 300, reel 400 further comprises of a reel body 402 which includes a wide range of components that create the functionality necessary for fishing including, but not limited to, a reel handle 403, as well as a reel foot 401 similar to reel foot 301, where reel foot 401 permits the mounting of reel 400 to a rod assembly 100 in a manner similar, or identical, to that described above with regard to reel 300.

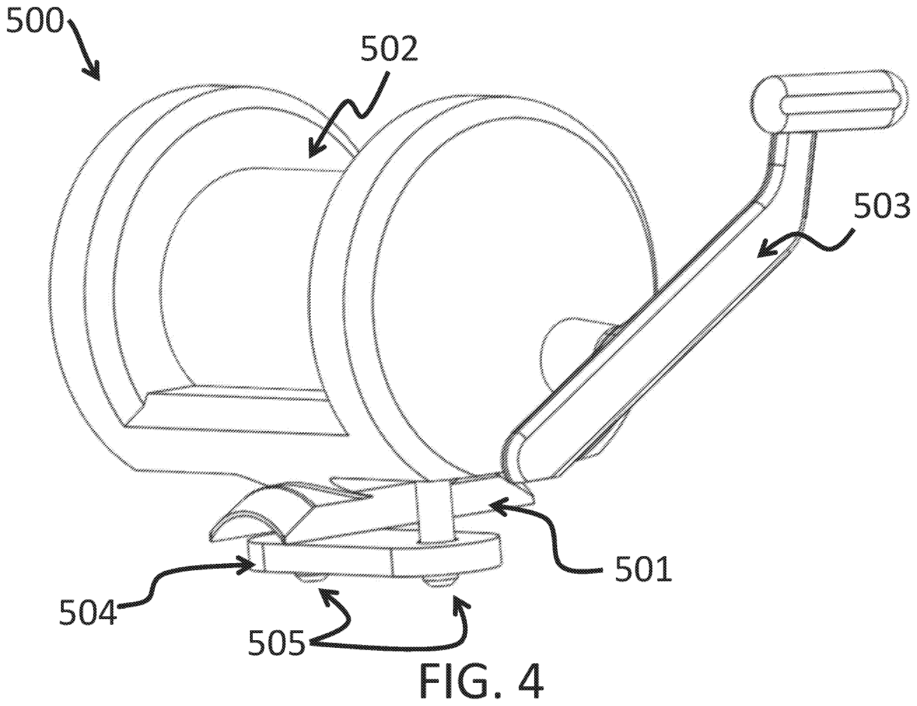

In FIG. 4, a baitcasting-/conventional-type fishing reel 500 is shown. In this case, reel 500 is able to be mounted to rod assembly 100 via a similar, or identical, manner as reel 300 due to reel foot 501. Similar to reel 300, reel 500 further comprises of a reel body 502 which includes a wide range of components that create the functionality necessary for fishing including, but not limited to, a reel handle 503, as well as a reel foot 501 similar to reel foot 301, where reel foot 501 permits the mounting of reel 500 to a rod assembly 100 in a manner similar, or identical, to that described above with regard to reel 300. Reel 500 can further optionally comprise a reel coupling plate 504 and coupling posts 505 to further ensure a secure connection to rod assembly 100. As would be apparent therefrom, the mounting process shown in the embodiments above for reels 400 and 500 do not prevent theft or unwanted removal of a reel from rod assembly 100.

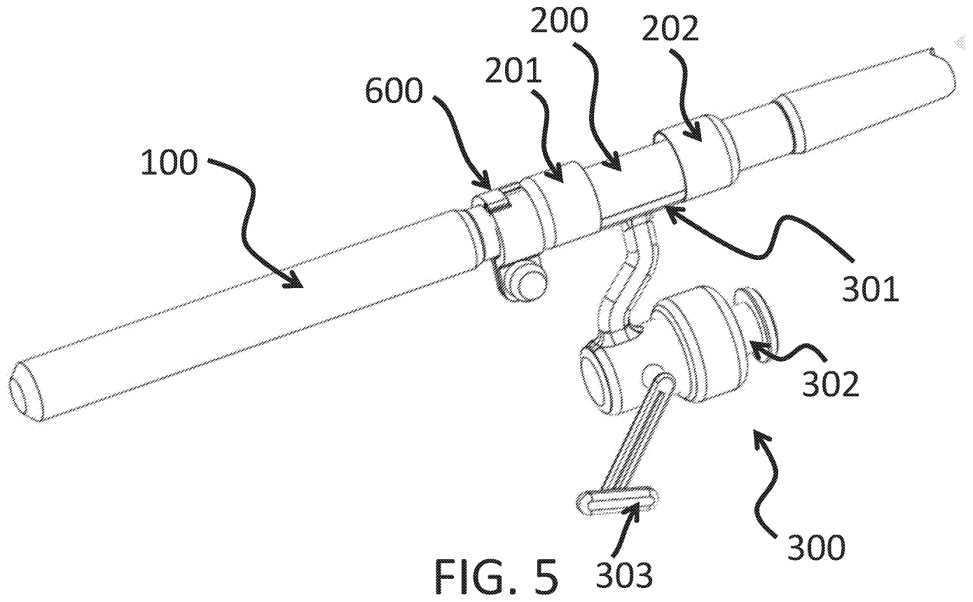

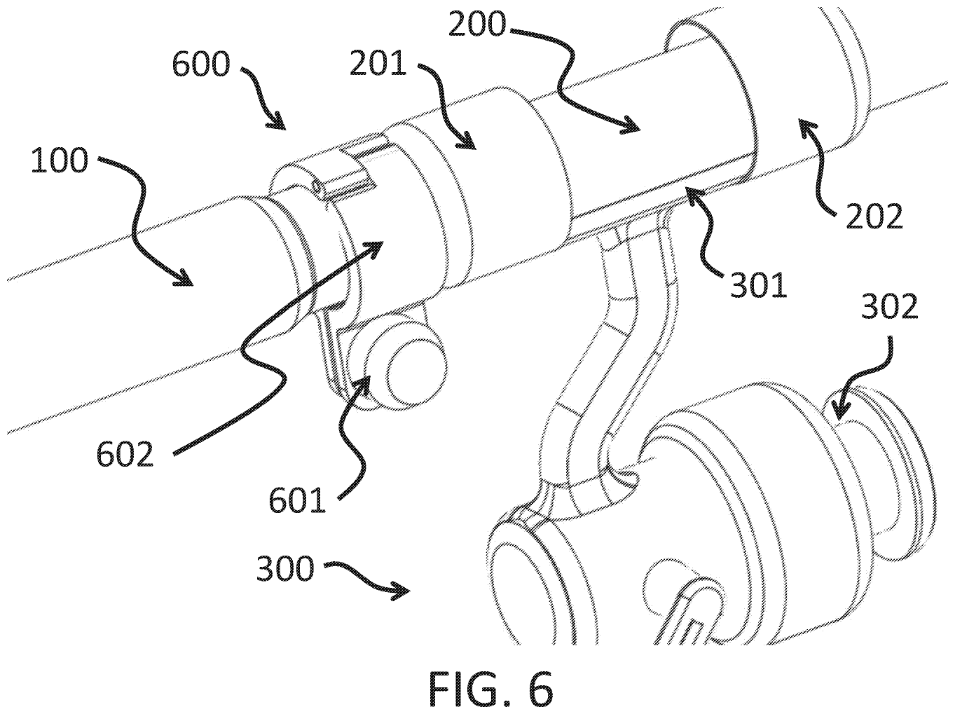

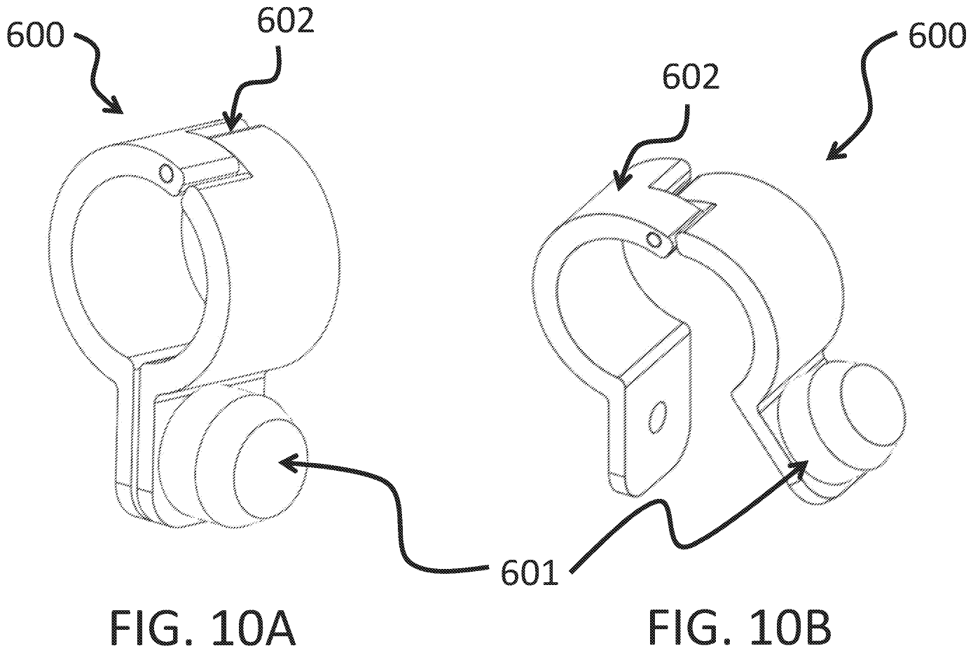

FIGS. 5 and 6 illustrate one embodiment of a reel locking system in accordance with the present invention, where the reel locking system is designed to prevent the theft or unwanted removal of any type of fishing reel including, but not limited to, reels 300/400/500 from a rod assembly 100. In this embodiment, the present invention removably or permanently locks a fishing reel such as spinning reel 300 (alternatively any of reels 400 and/or 500 could be substituted for reel 300) to rod 100 and/or reel seat 200. Locking system 600, which will be described in more detail with regard to FIGS. 10A and 10B, prevents movable reel seat securing member 201 from being loosened in an uncontrolled and/or unwanted manner, thus thereby preventing reel foot 301 from being released from reel seat 200 and thus rod assembly 100. In this embodiment, reel seat securing member 202 opposite of the movable reel seat securing member 201 is permanently fixed. Locking system 600 is comprised of a locking mechanism 601 and a locking body 602. Locking mechanism 601 can be permanent or removable and comprised of a mechanical locking system, an electro-mechanical locking system, an electrical locking system, or any other locking system that ensure the locking of locking system 600 so as to prevent locking system 600 from being opened in an uncontrolled and/or unwanted manner. The preferred embodiment of locking system 600 is a mechanical locking system comprising a pinned cylinder locking system, a magnetic locking system, or similar embodiments, since these systems would be more resistant to the various environmental factors that fishing rod and reel assemblies are typically subjected. One specific embodiment of the locking system of the present invention is a mechanical locking system that is a keyed pinned cylinder locking system.

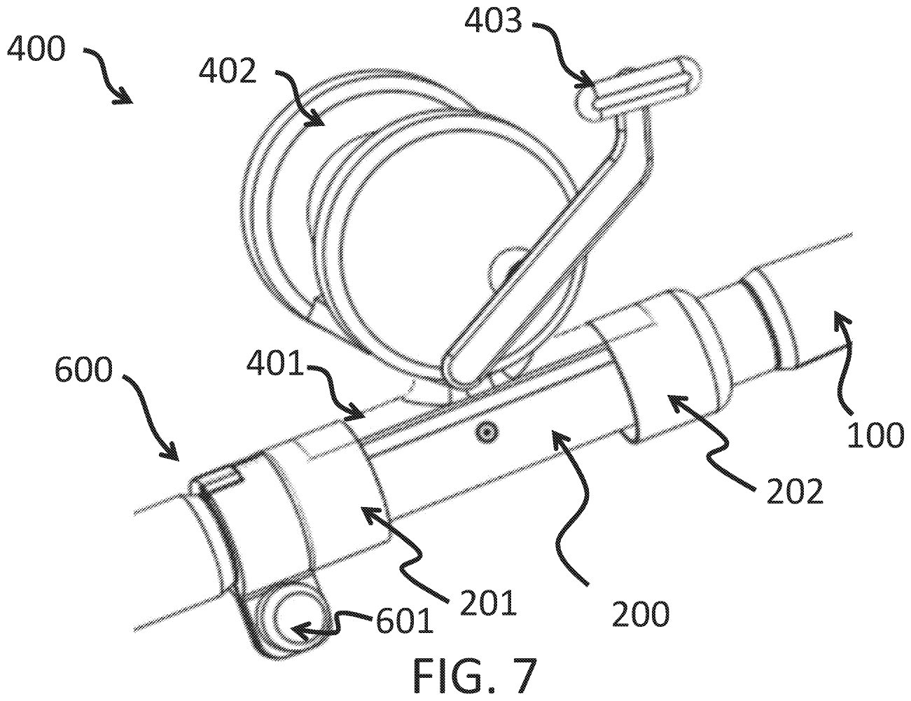

In another embodiment, as illustrated in FIG. 7, reel 400 (e.g., a casting reel) is securely attached to a rod assembly 100 using a locking system 600 according to the present invention. The embodiment of FIG. 7 includes a locking system for a casting reel and is equivalent to the embodiment illustrated in FIGS. 5 and 6 where the locking system is applied to a spinning reel. This embodiment removably or permanently locks reel 400 to rod 100 assembly via reel seat 200. Locking system 600 prevents the movable reel seat securing member 201 and/or movable reel seat securing member 202 from being loosened in an uncontrolled or unwanted manner and thus thereby preventing the reel foot 301 from being released from reel seat 200 and rod assembly 100. In one embodiment, either reel seat securing member 201 or 202 is movable, while the remaining reel seat securing member is permanently fixed. As would be apparent to those of skill in the art, locking system 600 is placed adjacent to the movable reel seat securing member regardless of whether that is item 201 or 202.

In one embodiment, locking system 600 is comprised of a locking mechanism 601 and a locking body 602. Locking mechanism 601 can be permanent or removable and can be comprised of a mechanical locking system, an electro-mechanical locking system, an electrical locking system, or any other locking system that ensures locking of locking system 600 in such a manner so as to prevent locking system 600 from being opened in an uncontrolled or unwanted manner. In one embodiment, locking system 600 is a mechanical system comprising a pinned cylinder locking system, a magnetic locking system, or similar embodiments, since these systems would be more resistant to the various environmental factors that fishing rod and reel assemblies are typically subjected. One specific embodiment of the locking system of the present invention is a mechanical locking system that is a keyed pinned cylinder locking system.

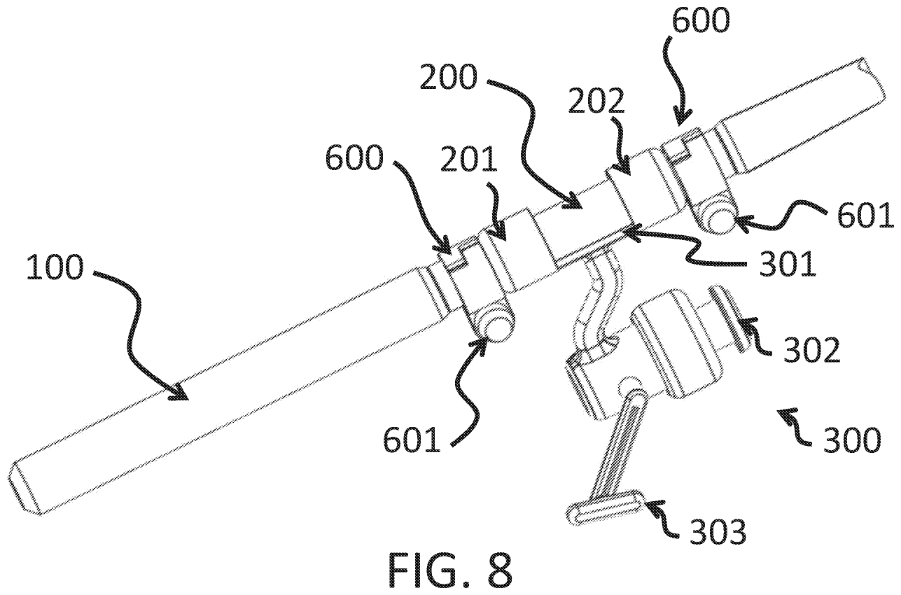

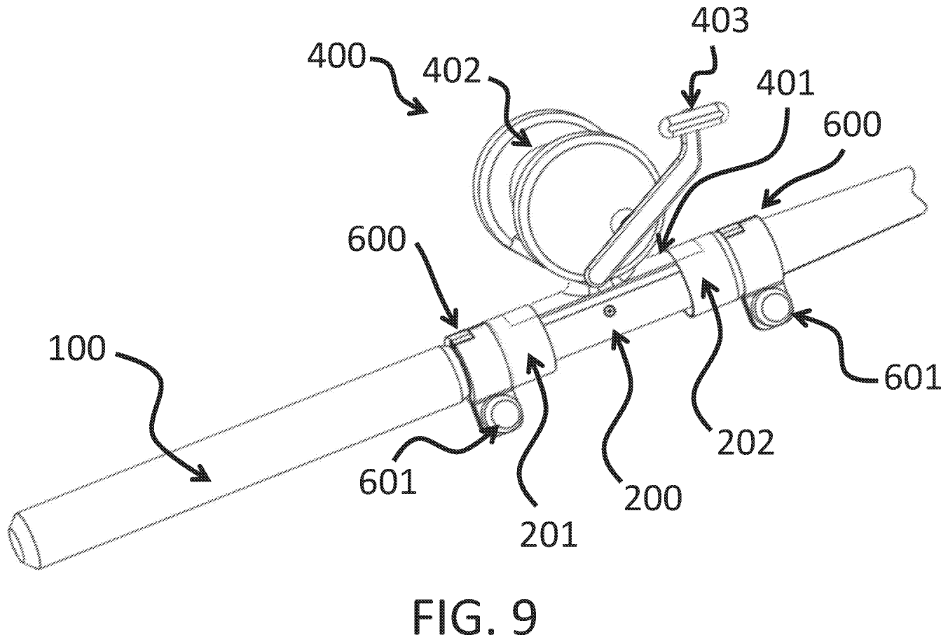

In another embodiment, as illustrated in FIGS. 8 and 9, a spinning or casting reel 300 and/or 400 is securely attached to rod assembly 100 using a locking system 600 according to the present invention so as to prevent the theft and/or unwanted removal of reel 300/400 from rod assembly 100. In this embodiment, the present invention removably or permanently locks reel 300/400 to rod assembly 100 and reel seat 200. Locking systems 600, which are described in more detail in FIGS. 10A and 10B, prevents the both reel seat securing members 201 and 202 from being loosened in an uncontrolled and/or unwanted way, thereby preventing reel foot 301/401 from being released from reel seat 200 and rod assembly 100. In this embodiment, as can be seen from FIGS. 8 and 9, both reel seat securing members 201 and 202 are movable and therefore each require their own locking systems 600 to ensure uncontrolled and/or unwanted removal of reel 300/400 from rod assembly 100 and seat 200. Locking systems 600 are each comprised of their own locking mechanism 601 and a locking body 602. Locking mechanisms 601 can be permanent or removable and be comprised of a mechanical locking system comprising a pinned cylinder locking system, a magnetic locking system, or similar embodiments, that ensure the locking of locking system 600 so as to prevent locking systems 600 from being opened in an uncontrolled and/or unwanted manner. One specific embodiment of the locking system of the present invention is a mechanical locking system that is a keyed pinned cylinder locking system as such a system is more resistant to the various environmental factors that fishing rod and reel assemblies are typically subjected. In another embodiment, reel 500 can be attached to rod assembly 100 in any manner described in FIGS. 5 through 9.

Turning to FIGS. 10A and 10B, these Figures provide a view of one embodiment of locking system 600, where locking system 600 is comprised of a locking structural member or locking body 602 and a locking component 601. In another embodiment, locking system 600 can have one, two, or multiple structural members 602 and one, two, or multiple locking members 601 that combine to ensure that one or more of reel seat securing members 201 and 202 cannot be undesirably moved/released so as to ensure that any of reels 300/400/500 are secured to rod assembly 100. In another embodiment, locking component 601 is removable using a key, a combination code, or other locking or securing method (e.g., a magnetically actuated locking member, etc.). In another embodiment, locking component 601 is a permanent locking device including, but not limited to, a weld, a rivet, some other form of permanent attachment, etc.

In all the embodiments related to locking system 600, locking system 600 partially or fully encapsulates rod assembly 100 and/or reel seat 200 in a manner that prevents locking system 600 from being undesirably moved and/or removed. The inability to move locking system 600 prevents the uncontrolled and/or unwanted removal of any one or more of reel 300/400/500 by ensuring that one, or both, of reel seat securing members 201 and 202 are prevented from moving. The inability to move and/or remove locking system 600 is established through the design of locking system 600 and can be accomplished by a range of mechanical, electrical, or other design options. In the embodiments present in FIGS. 10A and 10B, locking system 600 engages a threaded portion of reel seat 200 in a manner that prevents movement, especially along the long axis direction of rod assembly 100. In this embodiment, locking system 600 engages rod assembly 100 and one or more of reel seat securing members 201 and 202 simultaneously in a manner that prevents movement, especially along the long axis direction of rod assembly 100.

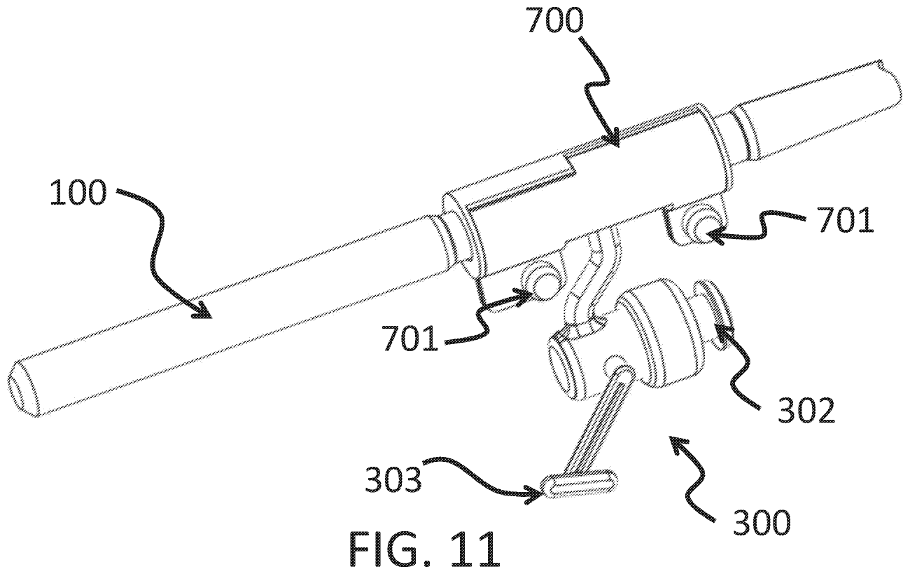

In another embodiment, as illustrated in FIG. 11, locking system 700 fully or partially encapsulates reel foot 301/401/501 and each foot's respective reel seat 200 so as to prevent one or more of reel seat securing members 201 and 202 from being undesirably loosened, thereby preventing uncontrolled and/or unwanted removal of reel 300/400/500 from rod assembly 100 and reel seat 200. In this embodiment, the present invention removably or permanently locks reel 300/400/500 to rod assembly 100 and reel seat 200. Locking system 700 prevents, in this instance, both reel seat securing members 201 and 202 from being loosened in an uncontrolled and/or unwanted manner, thereby preventing reel foot 301/401/501 from being released from its respective reel seat 200 and rod assembly 100.

In this embodiment, one or more of reel seat securing members 201 and 202 are movable. Locking system 700 is comprised of one or more locking mechanisms 701, with two being shown in FIG. 11, and locking body 702 that itself is comprised of one or more components. Locking mechanisms 701 can be permanent or removable and can be formed from a mechanical locking system, an electro-mechanical locking system, an electrical locking system, or any other locking system that ensures locking of locking mechanisms 701 in such a manner so as to prevent locking system 700 from being opened in an uncontrolled or unwanted manner. In one embodiment, locking mechanisms 701 are comprised of pinned cylinder locking systems, magnetic locking systems, or similar locking systems, as such systems are more resistant to the various environmental factors that fishing rod and reel assemblies are typically subjected. One specific embodiment of the locking system 700 of the present invention is a mechanical locking system that is a keyed pinned cylinder locking system.

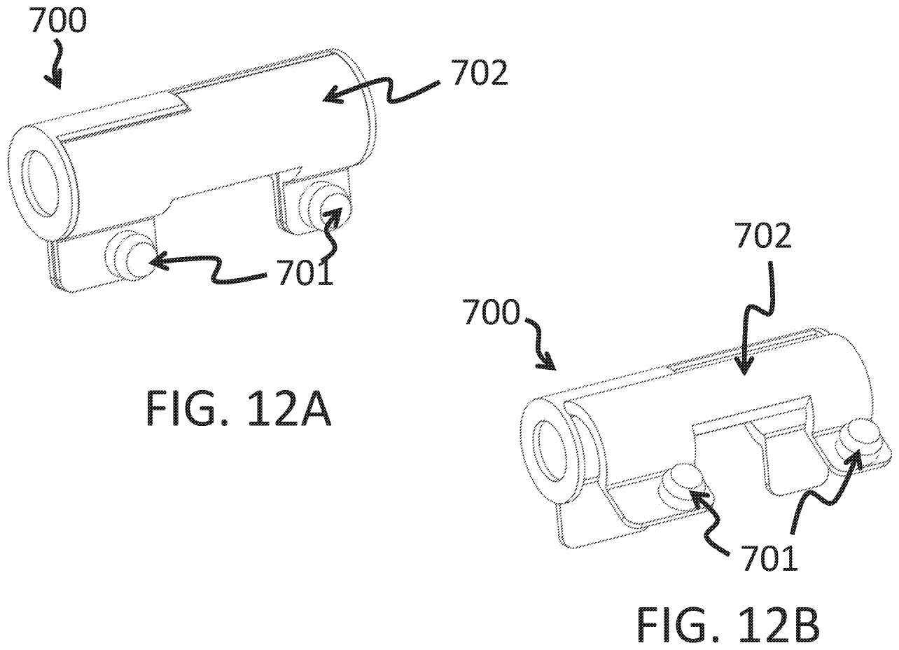

Turning to FIGS. 12A and 12B, these Figures provide a view of one embodiment of locking system 700, where locking system 700 is comprised of a locking structural member or locking body 702 and a locking component 701. In another embodiment, locking system 700 can have one or more structural members 702 and one or more locking members 701 that combine to ensure one or more, typically in this embodiment both, reel seat securing members 201 and 202 cannot be undesirably moved, thereby preventing the undesirable and/or unwanted release of reel 300/400/500. In another embodiment, locking component 701 is removable using a key, a combination code, or other locking or securing method (e.g., a magnetically actuated locking member, etc.) method. In another embodiment, locking component 701 is a permanent locking device including, but not limited, a weld, a rivet, some other form of permanent attachment, etc.

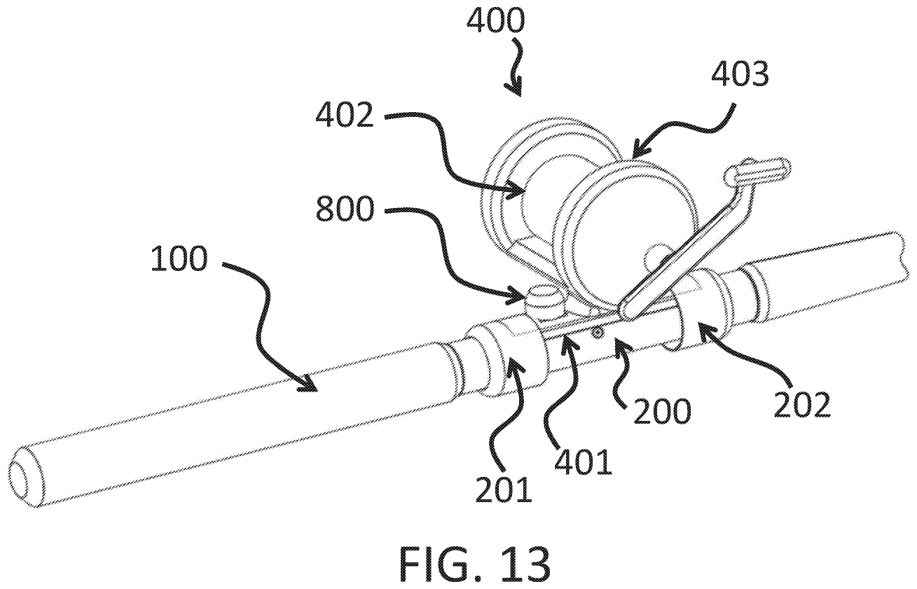

In another embodiment, as is illustrated in FIG. 13, locking system 800 is incorporated into reel 300/400/500, really into reel foot 301/401/501. In one embodiment, reel foot 301/401/501 has a single feature or multiple features that permits reel 300/400/500 to be removably or permanently locked to rod assembly 100 and reel seat 200 using locking system 800 that comprises a mechanical locking system, an electro-mechanical locking system, an electrical locking system, or any other locking system that ensures locking system 800 from being opened in an uncontrolled or unwanted manner. In one instance, locking system 800 is a pinned cylinder locking system, a magnetic locking system, or similar locking system, as such systems are more resistant to the various environmental factors that fishing rod and reel assemblies are typically subjected. One specific embodiment of the locking system 800 of the present invention is a mechanical locking system that is a keyed pinned cylinder locking system. In one embodiment, locking system 800 is comprised of a single locking component that pass through reel foot 301/401/501 and locks reel 300/400/500 to reel seat 200 by engaging a keyway, shaped hole, or circular hole in reel seat 200 in a manner that permits the various locking components to act together to permit the removable locking of reel 300/400/500.

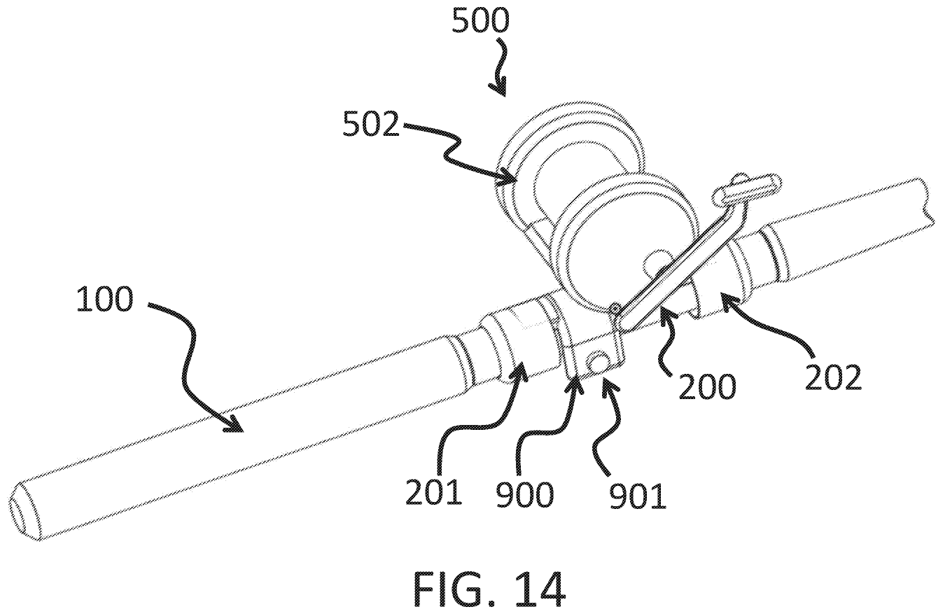

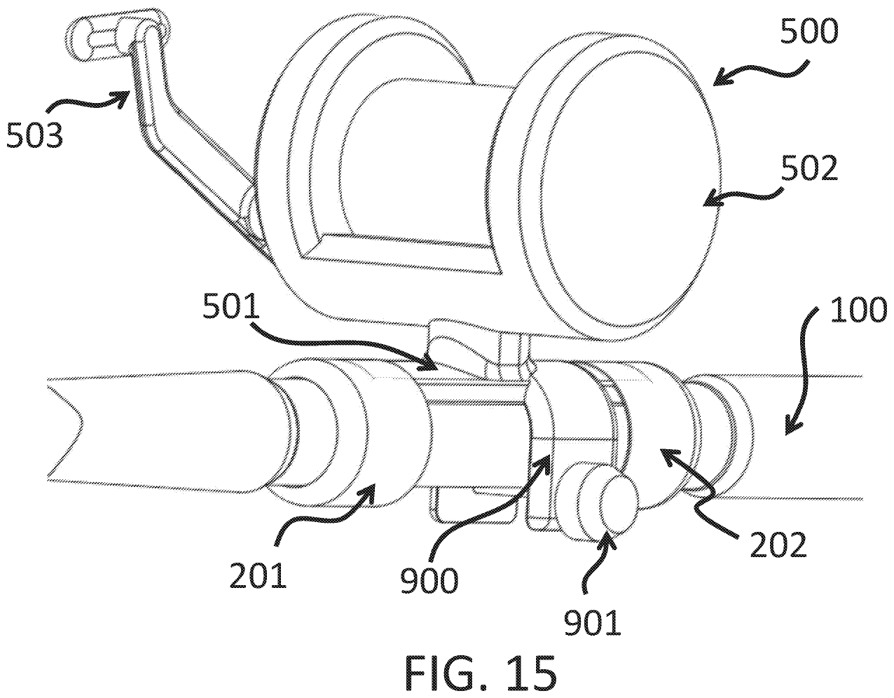

In another embodiment, as illustrated in FIGS. 14 and 15, locking system 900 comprises locking member 901 is incorporated into reel 300/400/500, and specifically into reel foot 301/401/501. In one embodiment, reel foot 301/401/501 has a single u-shaped feature or multiple u-shape features that permit reel 300/400/500 to be removably or permanently locked to rod assembly 100 and reel seat 200 using locking member 901. In another embodiment, reel foot 301/401/501 has a single notch or pocket feature or a series of notches or pocket features that permit locking system 900 to engage reel foot 301/401/501 and removably or permanently lock reel 300/400/500 to the rod assembly 100 and reel seat 200. Locking system 900 includes a u-shaped structural member or similar member that engages one or more notches in reel foot 301/401/501 thereby creating the removable or permanent locking system to rod assembly 100 and reel seat 200. Locking system 900 and locking member 901 comprises a mechanical locking system, an electro-mechanical locking system, an electrical locking system, or any other locking system that ensures locking of locking mechanism 901 in such a manner so as to prevent locking system 900 from being opened in an uncontrolled or unwanted manner. In one embodiment, locking mechanism 901 are comprised of pinned cylinder locking systems, magnetic locking systems, or similar locking systems, as such systems are more resistant to the various environmental factors that fishing rod and reel assemblies are typically subjected. One specific embodiment of the locking system 900 of the present invention is a mechanical locking system that is a keyed pinned cylinder locking system.

Locking system 900 can include one or more structural members and/or one or more locking components. In one embodiment, locking system 900 is comprised of a single locking component 901 that pass through reel foot 301/401/501 and locks reel 300/400/500 to reel seat 200 by engaging a keyway, shaped hole, or circular hole in reel seat 200 in a manner which allows for locking the components together in a removable manner.

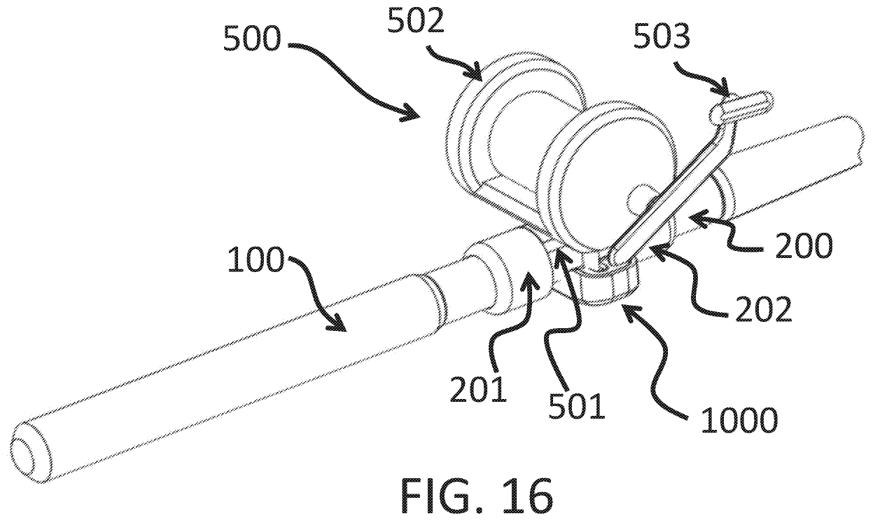

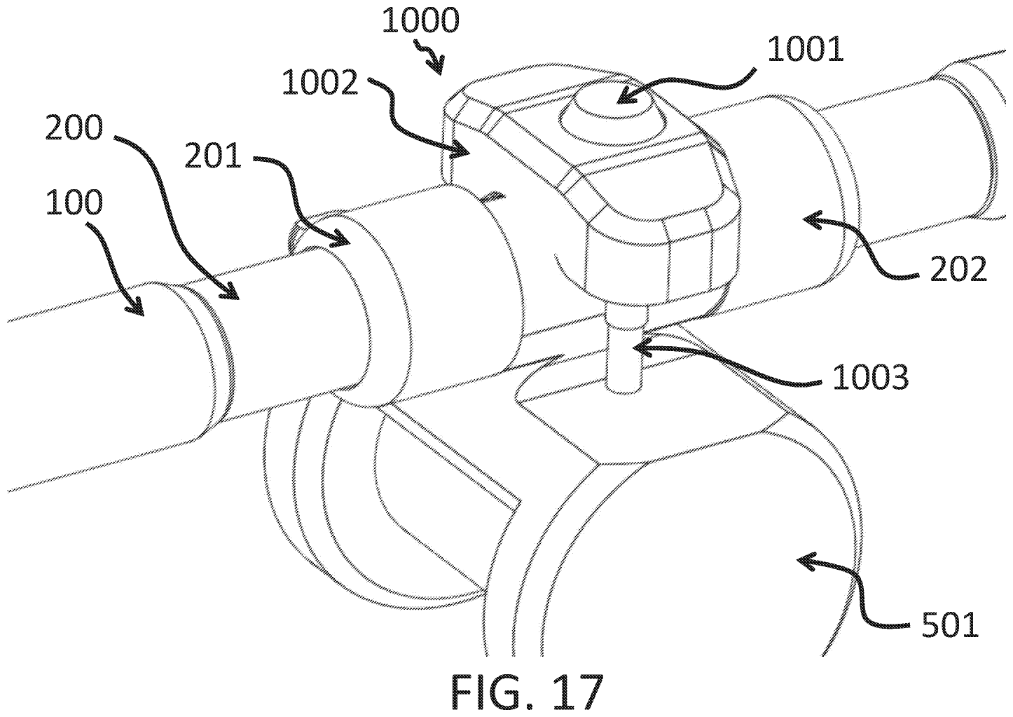

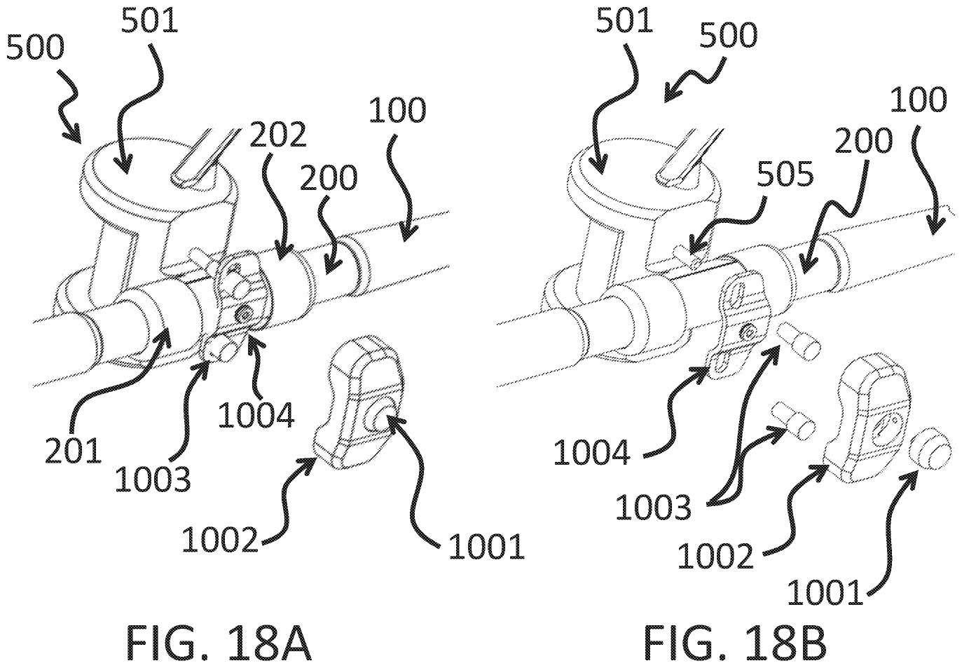

In another embodiment, as is illustrated in FIGS. 16 through 20C, locking system 1000 replaces existing reel coupling plate 504 and mounts to coupling posts 505 and/or integrates into an existing reel coupling plate 504 and coupling posts 505. Locking system 1000 is comprised of structural member 1002, locking member 1001, structural mounting plate 1004, and one or more attaching components 1003. In one specific embodiment, structural mounting plate 1004 is designed to replace reel coupling plate 504. However, in other embodiments structural mount plate 1004 can connect to an existing reel coupling plate 504. In still other embodiments, structural mount plate 1004 is not be required since existing reel coupling plate 504 can be capable of being used as a replacement for structural mounting plate 1004. Structural mounting plate 1004 is used to connect reel 500 to rod assembly 100 and reel seat 200 using the one or more attaching components 1003 which connect to coupling posts 505. Attaching components 1003 can be threaded, magnetic, welded, or any variety of attachment methods. In most embodiments, coupling post 505 on reel 500 will be threaded posts therefore attaching components 1003 will be threaded members.

Further, locking members 1001 can be permanent or removable and comprised of mechanical, electro-mechanical, electrical, or other systems that ensure the locking of system 100 so as to prevent system 1000 from being opened in an uncontrolled and/or unwanted manner. In one embodiment, a locking system is formed from a mechanical system comprising a pinned cylinder locking system, a magnetic locking system, or a similar system, as such systems are more resistant to the various environmental factors that fishing rod and reel assemblies are typically subjected. One specific embodiment of the locking system 1000 of the present invention is a mechanical locking system that is a keyed pinned cylinder locking system.

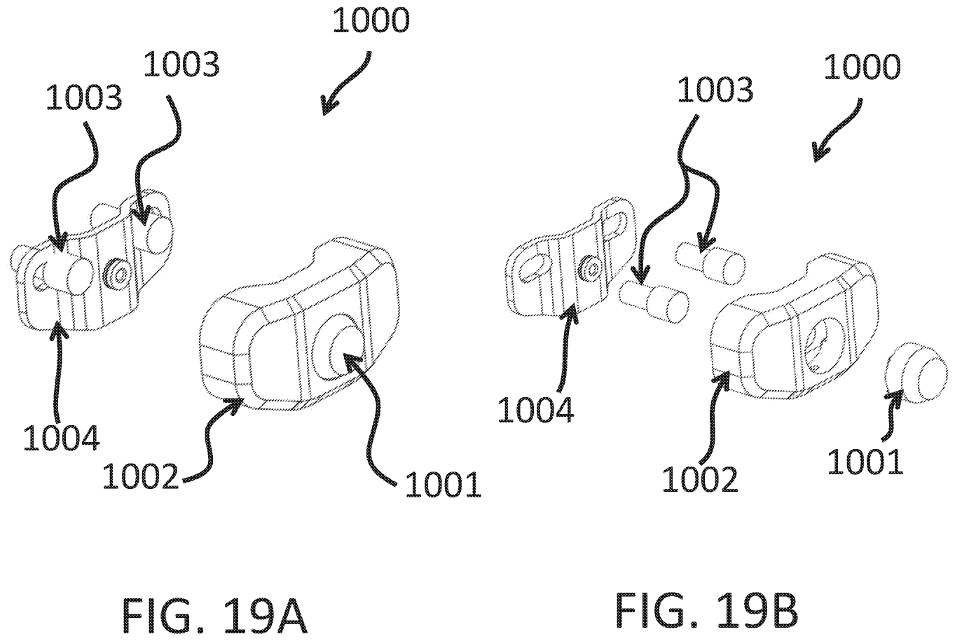

In another embodiment, as illustrated in FIGS. 19A and 19B, locking system 1000 is formed from a lock 1001, a structural member 1002, a mounting structural plate 1004, and one or more attaching components 1003. Structural mounting plate 1004 is design to replace or mount to coupling plate 504. In one specific embodiment, coupling plate 504 is replaced to create so as locking system 1000 is designed to have the smallest volume. In this embodiment, structural mounting plate 1004 is placed over reel coupling posts 505 and then attaching components 1003 are mounted to reel coupling posts 505. Once structural mounting plate 1004 is attached, structural member 1002 can be attached to structural mounting plate 1004 using lock 1001. Once locked, lock mechanisms 1001 may be permanent or removably attached.

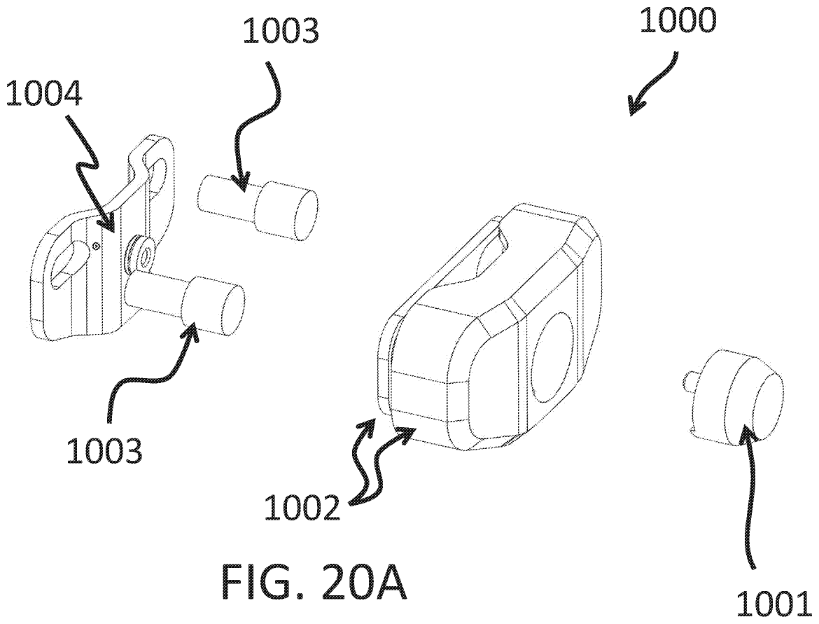

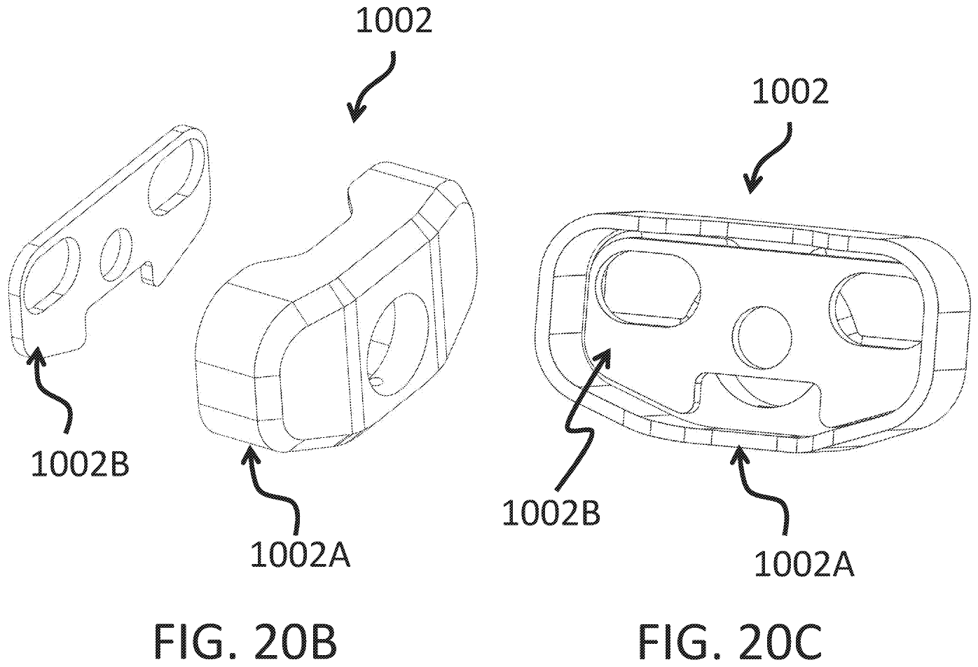

In another embodiment, as illustrated in FIGS. 20A, 20B and 20C, locking system 1000 is formed from a lock 1001, a structural member 1002, a mounting structural plate 1004, and one or more attaching components 1003. Structural member 1002 can be comprised of one or more components as shown in FIGS. 20A, 20B and 20C. The components of structural member 1002 can be made of metal, polymer, wood, stone, or a combination of these materials. In one specific embodiment, structural member 1002 is made of two components 1002A and 1002B where 1002A is made of a polymer or metal material and 10028 is made of metal. Components 1002A and 1002B are used together and can be mechanically joined with threaded, magnetic, welded, or any variety of other attachment methods.

Although the invention has been described in detail with particular reference to certain embodiments detailed herein, other embodiments can achieve the same results. Variations and modifications of the present invention will be obvious to those skilled in the art and the present invention is intended to cover in the appended claims and all such modifications and equivalents.

What is claimed is:

1. A fishing reel locking system that detachably locks a fishing reel to a fishing rod comprising:
a reel seat formed in the fishing reel, where the reel seat is designed to receive at least one type of fishing reel having therein a reel foot;
at least one reel seat securing member formed on at least one end of the reel seat, where the at least one reel seat securing member is designed to movably engage at least one portion of the reel foot of the fishing reel to be secured to the fishing rod; and
at least one locking system designed to prevent the unwanted, or undesired, movement of the at least one reel seat securing member, thereby preventing the unwanted, or undesired, removal of the fishing reel from the fishing rod.

2. The fishing reel locking system of claim 1, wherein the fishing reel locking system further comprises two reel seat securing members, where each respective reel seat securing member is located at an opposite end of the reel seat.

3. The fishing reel locking system of claim 2, wherein the fishing reel locking system further comprises two locking systems each designed to prevent the unwanted, or undesired, movement of one respective reel seat securing member.

4. The fishing reel locking system of claim 1, wherein the at least one fishing reel locking system comprises a mechanical locking system, an electro-mechanical locking system, or an electrical locking system that ensures locking of the fishing reel to the fishing rod.

5. The fishing reel locking system of claim 1, wherein at least one fishing reel locking system comprises a pinned cylinder locking system.

6. The fishing reel locking system of claim 1, wherein at least one fishing reel locking system permanently locks the fishing reel to the fishing rod.

7. The fishing reel locking system of claim 1, wherein at least one fishing reel locking system removably locks the fishing reel to the fishing rod.
